(19) United States
(12) Patent Application Publication
(10) Pub. No.: US 2026/0251396 A1
(43) Pub. Date: Aug. 27, 2026

(54) FURNACE ENVIRONMENT INSPECTION SYSTEM AND METHOD

(71) Applicant: Tallman Technologies Inc., Burlington (CA)

(72) Inventors: Michael James STRELBISKY, Burlington (CA); Majid ZAMANI, Burlington (CA); Aaron Michael Conrad STRELBISKY, Burlington (CA)

(21) Appl. No.: 19/544,564

(22) Filed: Feb. 19, 2026

Related U.S. Application Data
(60) Provisional application No. 63/761,329, filed on Feb. 21, 2025.

(51) Int. Cl. F27D 21/02; F27D 21/00

(52) U.S. Cl. CPC F27D 21/02; F27D 2021/0057

(57) ABSTRACT

A method for determining obtaining preselected information in a furnace environment, the method including directing an information gathering gas jet into the furnace environment to displace an upper material located on top of a lower material in order to expose a portion of the lower material. The method further including using an inspection device to obtain preselected information from the exposed portion of the lower material and then processing the preselected information.

### CROSS-REFERENCE TO OTHER APPLICATIONS

The disclosure claims priority from U.S. Provisional Application No. 63/761,329 filed Feb. 21, 2025, which is hereby incorporated by reference.

### FIELD

The present disclosure is generally directed at furnace environments and, more specifically at a furnace environment inspection system and method.

### BACKGROUND

As is well known in the art, an operator may need to obtain information via a suitable inspection device (e.g., a suitable camera) in real time about a process inside a chamber that encloses a high particle impact environment. In a high particle impact environment, particles may be directed toward the inspection device, at relatively high velocity. The high particle impact environment may be, for example, inside an electric arc furnace or a basic oxygen furnace during its operation. Inside the furnace, a wide variety of particles of varying size may be ejected at high velocity due to process reactions (e.g., from a steel bath), impacting the camera, or otherwise impeding observation of the process or the process materials.

High temperatures inside the electric arc furnace or the basic oxygen furnace also complicate inspection inside it. In these furnaces, both the high impact particles and the high temperatures make observation or inspection of the process difficult. Typically, the high impact particles are relatively hot, and may be semi-solid. The high impact particles may tend to accumulate or agglomerate on any exposed surfaces. For purposes hereof, the temperatures in a high-temperature environment may be between approximately 100° C. and approximately 1,700° C.

In the prior art, direct measurement of a temperature of a steel bath has been extremely difficult to achieve. Among things, due to a layer of slag foam located on the steel bath during steelmaking, direct access to the steel bath is generally not available. For the same reason, determining the height of the steel bath (i.e., the location of the surface of the steel bath in relation to a reference point) is difficult using conventional methods.

The conventional cameras designed for use in these difficult environments (i.e., environments with high impact particles and/or high temperatures) are not designed for continuous observation. Conventional high-temperature camera units are subject to damage by high impact particles and high temperatures, when exposed to the chamber.

Accordingly, the conventional high-temperature camera may be retracted after an image is obtained, to avoid overheating the camera. Alternatively, the conventional camera may be protected by a door or shutter when not obtaining images, although the door or shutter limits the images that are obtainable.

If the prior art camera unit includes a shutter or door that may be closed to protect the camera, then when the door is closed, it may be impacted by high impact particles, which may accumulate to impede or prevent operation of the shutter device.

Typically, the camera is located in a water-cooled jacket. However, this introduces a risk that water may be released therefrom into the furnace, which may be dangerous.

The known high-temperature camera units may provide for air to be blown across the camera lens, in an attempt to protect the lens. However, this arrangement does not prevent high-velocity and/or high-temperature particles from impacting the camera.

### SUMMARY

For the foregoing reasons, there is a need for a furnace environment inspection system and method that overcomes or mitigates one or more of the defects or deficiencies of the prior art.

In its broad aspect, the disclosure provides a method of obtaining preselected information in a furnace environment in which process materials are subjected to a process. The process materials include a lower material and an upper material positioned at least partially on the lower material. The method includes, first, positioning an inspection assembly for aiming first and second gas jets from the inspection assembly into the furnace environment. The second gas jet is directed onto the upper material at a preselected location thereon, so that the second gas jet displaces a part of the upper material to expose an exposed portion of the lower material. With an inspection device, the preselected information is obtained from the exposed portion of the lower material.

In one aspect of the disclosure, there is provided a method of obtaining preselected information in an environment in which process materials are subjected to a process, the process materials including a lower material and an upper material, the upper material positioned at least partially on the lower material, the method including positioning an inspection assembly for aiming an information gathering gas jet from the inspection assembly into the environment; directing the information gathering gas jet onto the upper material at a preselected location thereon, wherein the information gathering gas jet displaces a part of the upper material to expose an exposed portion of the lower material or to upwardly propel the lower material; and with an inspection device, obtaining the preselected information from the lower material.

In another aspect, the preselected information from the lower material is obtained from a top surface of the lower material. In yet another aspect, the preselected information is an image of the top surface of the lower material. In a further aspect, the preselected information is microwaves reflected off the top surface of the lower material. In another aspect, the method further includes directing a cooling and protective gas jet from the inspection assembly into the environment. In an aspect, a density, volume or velocity of the information gathering jet is different from the cooling and protective gas jet. In yet a further aspect, the method includes processing the preselected information. In a further aspect, the method further includes controlling characteristics of the environment based on the processed preselected information.

### BRIEF DESCRIPTION OF THE DRAWINGS

The disclosure will be better understood with reference to the attached drawings, in which:

FIG. 1 is an isometric view of an embodiment of an inspection assembly of the disclosure;

FIG. 2 is an isometric view of an embodiment of a panel subsystem of the disclosure, drawn at a smaller scale;

FIG. 3 is a rear side view of the panel subsystem of FIG. 2;

FIG. 4 is a front side view of the panel subsystem of FIGS. 2 and 3;

FIG. 5A is a schematic illustration of an embodiment of a system of the disclosure in which a jet of gas is directed to a preselected location on a top surface of an upper material on a lower material in a furnace environment;

FIG. 5B is a schematic illustration of the system of FIG. 5A in which a part of the upper material is moved to expose a portion of the lower material;

FIG. 5C is another schematic illustration of the system of FIGS. 5A and 5B and the upper material and the lower material in which preselected information is obtained from the exposed lower material;

FIG. 6A is a partially cut away isometric view of an interior of an electric arc furnace with embodiments of the panel subsystems of the disclosure mounted in a wall thereof, drawn at a smaller scale; and

FIG. 6B is a portion of the electric are furnace of FIG. 6A, drawn at a larger scale.

### DETAILED DESCRIPTION

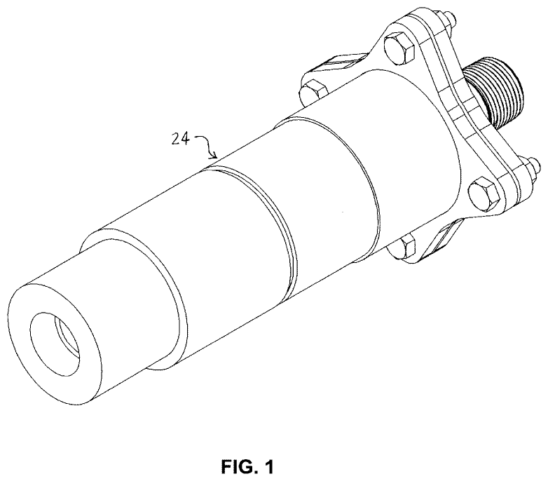

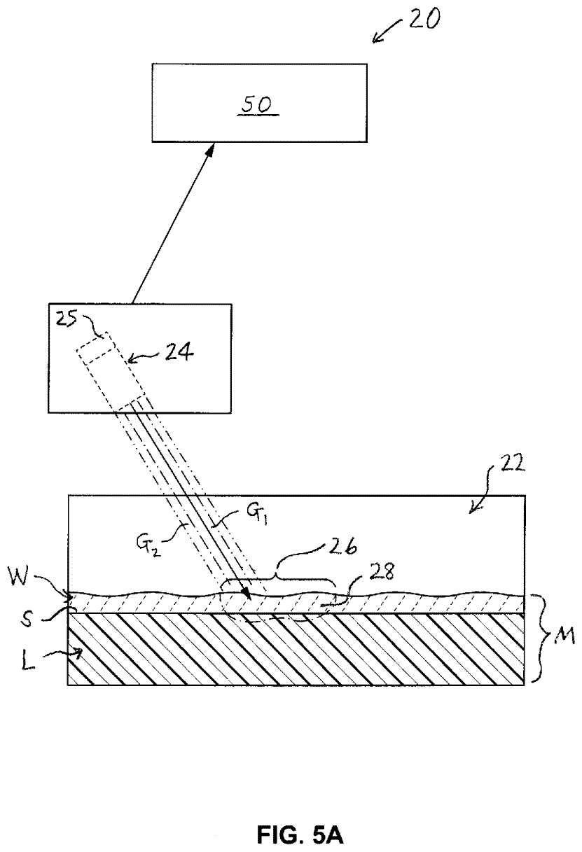

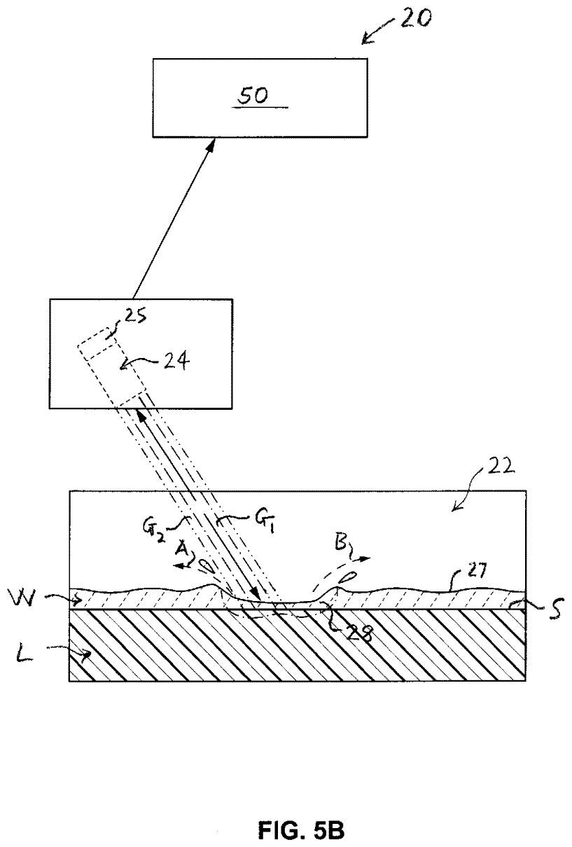

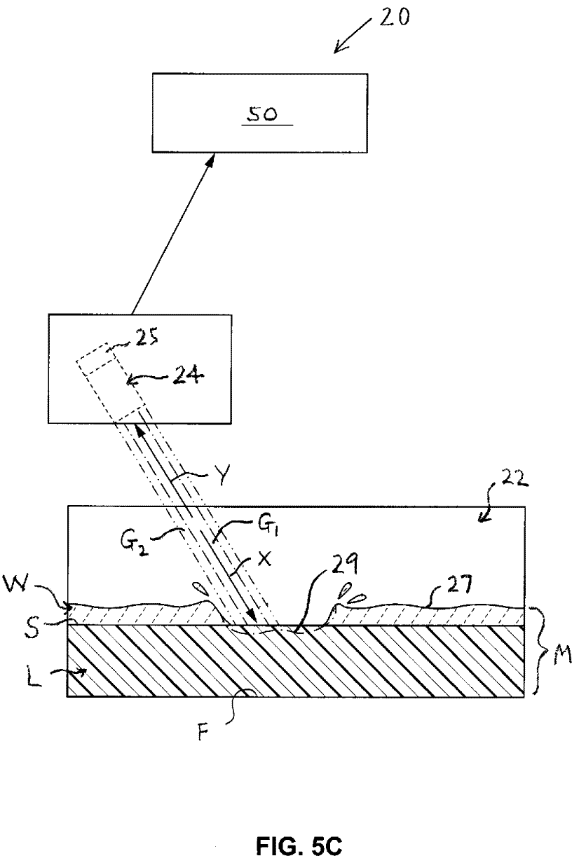

In the attached drawings, like reference numerals designate corresponding elements throughout. Reference is made to FIGS. 1-6B to describe an embodiment of a system in accordance with the disclosure indicated generally by the numeral 20 (FIGS. 5A-5C).

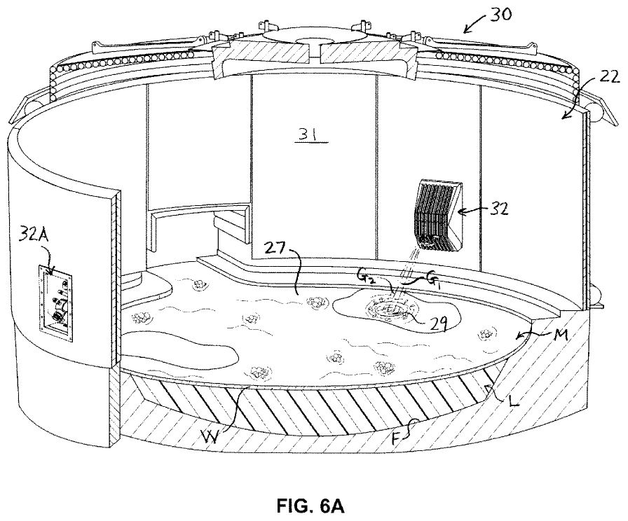

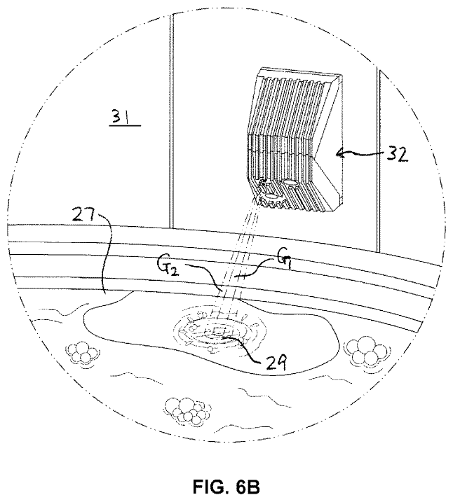

As will be described, the system 20 is for obtaining preselected information in a furnace environment 22 (FIGS. 5A-5C, 6A) in which process materials “M” are subjected to a process. In the example illustrated in FIGS. 5A-5C and 6A, the process materials “M” include a lower material “L” and an upper material “W” that is positioned at least partially on the lower material “L”. Examples of preselected information include, but are not limited to, a temperature of the material “M”, more specifically, a temperature of a surface of the lower material “L”, a temperature of the furnace environment and/or a position of the lower material with respect to the furnace environment 22. Further examples of preselected information are discussed below.

It is understood that the system 20 may also be used in other environments where information is to be gathered with different upper and lower materials that are different from each other. Examples include, but are not limited to, water tanks, oil tanks and the like.

As further shown in FIG. 5A-5C, the system 20 includes a processor 50 that is in communication with an inspection assembly 24 that includes an inspection device 25. A perspective view of one embodiment of the inspection assembly 24 is shown in FIG. 1.

The inspection assembly 24 is configured for directing a set of high velocity gas jets towards the process materials “M”. In one embodiment, the set of high velocity gas jets include a first (or cooling and protective) high velocity gas jet “G₁” and a second (or information gathering) high velocity gas jet “G₂” that are directed by the inspection assembly 24 inside the furnace environment 22 (FIGS. 5A-5C) where the velocities of the first gas jet and the second gas jet are different from each other. In some embodiments, the inspection assembly 24 may only direct the second gas jet as described in more detail below.

The process materials “M” may be any materials in which the upper material “W” is at least partially positioned on the lower material “L”. Either or both of the upper and lower materials may be liquid, or solid, or mixtures thereof, and/or gases, e.g., the upper and lower materials may include foam or foam-like material. In general, due to the process to which they have been subjected, the process materials may be positioned in two layers (i.e., the upper material being at least partially positioned on the lower material) because of differences in density or due to other differences in characteristics between the upper material and the lower material.

An example of the furnace environment 22 from which the inspection assembly 24 may obtain the preselected information is illustrated in FIGS. 6A and 6B. The furnace environment 22 of FIGS. 6A and 6B is schematically illustrated in FIGS. 5A-5C. In FIG. 6A, the furnace environment 22, such as, but not limited to, inside an electric arc furnace 30 is partially defined by a wall 31 and a floor “F”. It will be understood that a number of elements of the electric arc furnace 30 that do not form part of the disclosure are omitted from FIGS. 6A and 6B for clarity of illustration.

In the example illustrated in FIGS. 6A and 6B, steelmaking is underway in the furnace environment 22. In one example of materials as schematically shown in FIGS. 6A and 6B, the lower material “L” is liquid steel, and the upper material “W” is a slag foam layer that is positioned on the lower material “L”. However, those skilled in the art would appreciate that embodiments of the inspection assembly may be used in connection with processes other than steelmaking where the upper material “W” and the lower material “L” are different materials.

The inspection assembly 24 may have any suitable configuration, and the inspection assembly illustrated in FIG. 1 is only one example. The inspection assembly may be somewhat similar, in some respects, to the inspection assembly described in PCT/CA2024/050762, published on Dec. 12, 2024 as WO 2024/250110, entitled “INSPECTION ASSEMBLY FOR A FURNACE ENVIRONMENT” which is hereby incorporated herein by reference.

In the inspection assembly described in PCT/CA2024/050762, an inspection device is shrouded by one or more streams of high velocity gases (at the same or similar velocities) directed through and from the inspection assembly 24, which serve to protect the inspection device from high impact particles, and from high temperatures, in the furnace environment 22. However, the one or more streams of gases that are directed through the inspection assembly of PCT/CA2024/050762 are at approximately the same velocity and have the same characteristics. It will be understood that the inspection assembly 24 may differ from the inspection assembly described in PCT/CA2024.050762 in other aspects as described below.

In contrast, in one embodiment of the inspection assembly 24 of the disclosure, the first or cooling and protective gas jet “G₁” has different characteristics than the second or information gathering gas jet “G₂”. The characteristics may include, but are not limited to, velocity of the gas jet, density of the gas jet and/or volume of the gas jet. In some embodiments, the first or cooling and protective gas jet “G₁” is sufficient to protect the inspection device 25, but the second gas jet “G₂” is at at least one of a higher velocity, a greater volume and/or a greater density.

The characteristics of the second, or information gathering gas jet “G₂” are selected so that the information gathering gas jet is able to move or displace some of the upper material “W” to expose the lower material “L” or to propel some of the lower material “L” upwards such that the inspection device 25 can gather or retrieve preselected information from the exposed lower material or the upwardly propelled lower material. In some embodiments, the upper material “W” may be seen as waste material. Accordingly, in the inspection assembly 24 of the disclosure, the inspection assembly 24 is able to generate at least two gas jets having different characteristics for different purposes. In one embodiment, the inspection assembly includes a single device for producing or generating the different gas jets having different characteristics, such as velocity, density and/or volume.

It will be understood that, in an alternative embodiment, the gas jets “G₁”, “G₂” may be produced by two different devices, e.g., two physically distinct devices within the inspection assembly 24. In yet another embodiment, the inspection assembly 24 may include a single device for producing only the second or information gathering gas jet. For convenience, only one inspection assembly, capable of producing two gas jets, is illustrated.

In some circumstances, the lower material may only be partially covered by the upper material, and it may be possible to obtain data from the lower material “L” while using only the first gas jet “G₁” as will be described below.

The inspection assembly 24 is utilized to obtain preselected information in the furnace environment 22. The inspection device 25 may be, for example, a camera, or a microwave unit. The preselected information therefore may be, for example, one or more images of the exposed lower material (obtained by the camera), from which the temperature of the lower material may be determined. For example, the camera may capture an infra-red image of the exposed lower material “L” and then transmits the image to the processor 50 which then processes the image to determine a temperature based on the infra-red image. Alternatively, the preselected information may be, for example, the location of the exposed portion of the lower material (obtained via the microwave unit), to enable a determination of the location thereof relative to the floor “F”. The inspection assembly 24 may include more than one inspection devices 25 to obtain the different preselected information (e.g., temperature measurement, distance measurement, visual information, light intensity, etc.).

As schematically shown in FIGS. 5A to 5C, the inspection assembly 24 is positioned for aiming the second gas jet “G₂” therefrom onto the upper material “W” at a preselected location 26 on a top surface 27 of the upper material “W”, to displace a part or portion 28 of the upper material “W”, for exposing a portion or area 29 of the lower material “L” (FIGS. 5A, 5B, 5C). In some embodiments, the second gas jet “G2” may be directed into the lower material to expose a portion of the lower material beneath a top surface of the lower material.

In some embodiments, it is also preferred that, at the same time, the first gas jet “G₁” is directed from the inspection assembly 24 into the furnace environment, to protect and to cool the inspection device 25. In these embodiments, the inspection assembly 24 may include multiple channels whereby the inspection assembly 24 is able to direct multiple gas jets at one time. In some embodiments, the first gas jet may be continuously flowing to continuously cool and protect the inspection assembly 24.

Those skilled in the art would appreciate that, in general, directing the information gathering gases from the inspection assembly 24 into the furnace environment 22 should be minimized or limited, and therefore the second gas jet “G₂” is used as little as possible as there is a need to protect the protect against the lower material from absorbing gases and for insulting the lower material.

It will be understood that different steps in with respect to a method of obtaining preselected information are illustrated in FIGS. 5A-5C respectively. In FIG. 5A, the information gathering gas jet “G₂” is shown initially directed at or onto the top surface 27 of the upper material at the preselected location 26. As can be seen in FIG. 5A, the first gas jet “G₁” is also directed from the inspection assembly 24, however, the first gas jet “G₁” is at a lower velocity, and only intended for protecting the inspection device 25 from particles ejected from the furnace environment 22 towards the inspection assembly 24 or inspection device 25, and for cooling the inspection device 25.

In FIG. 5B, the part 28 of the upper material that is being displaced is shown at a point where the part 28 is only partially removed. It will be understood that FIG. 5B shows the situation inside the furnace environment 22 after the second gas jet “G₂” has removed at least some of the part 28 of the upper material “W” in order to expose a portion 29 of the lower material. The portion 29 may be seen as an exposed portion 29.

In FIG. 5C, the portion 29 is shown to be exposed. Once the exposed portion 29 is exposed, the preselected information may be obtained.

In one embodiment, using the inspection device 25 that is included in the inspection assembly 24, the preselected information is directly obtained from the exposed portion 29 of the lower material “L” (FIG. 5C). In one example, the inspection device 25 can take a thermal image of the exposed portion 29 and then transmits the thermal image to the processor 50 which then processes the thermal image to calculate or determine a temperature of the exposed portion 29 based on the thermal image.

It will also be understood that, in the method of using an inspection assembly described in PCT/CA2024/050782, the stream of gases shrouding the inspection device of the inspection assembly utilized therein is at a velocity that is not sufficient to displace the part 28 of the upper material “W” but protects the inspection device 25. In contrast, the method of the disclosure herein requires that the information gathering gas jet “G₂” directed through the inspection assembly 24 be at a higher velocity, so that the gas jet “G₂” displaces the part 28 of the upper material “W”, as illustrated, for example, in FIGS. 5A-5C.

In one embodiment, the inspection assembly 24 is included in a panel assembly 32 that is mounted to the wall 31 of the electric arc furnace 30 (FIGS. 6A, 6B).

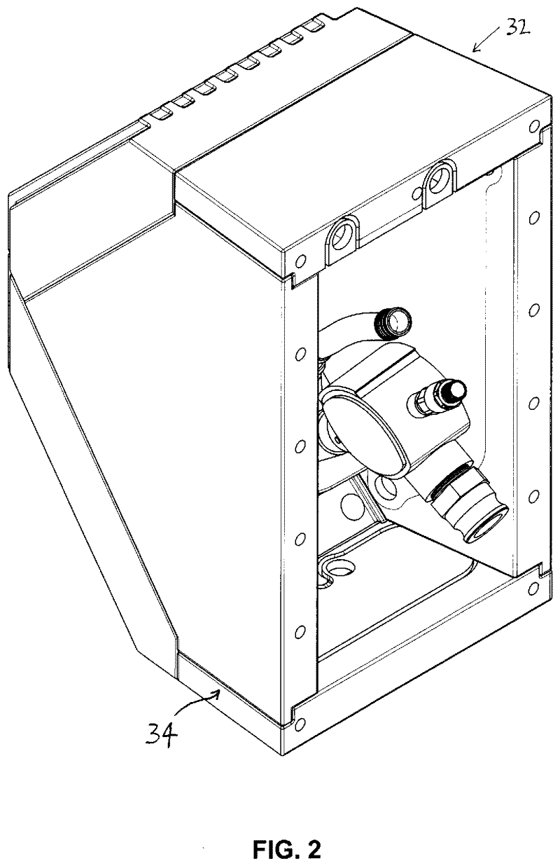

An embodiment of the panel assembly 32 is illustrated in FIGS. 2-4. In one embodiment, the panel assembly 32 includes a panel body 34, and may include one or more injector assemblies, and one or more inspection assemblies 24 (FIGS. 2-4). However, those skilled in the art would appreciate that, for the purposes hereof, the panel assembly 32 may alternatively include only one inspection assembly 24, and the injector assemblies may be omitted. As can be seen in FIG. 6A the panel assembly 32 is positioned on the wall 31 of the electric arc furnace 30 at a relatively low location, so that the inspection assembly 24 is proximal, proximate or close to the surface 27 of the process materials “M”.

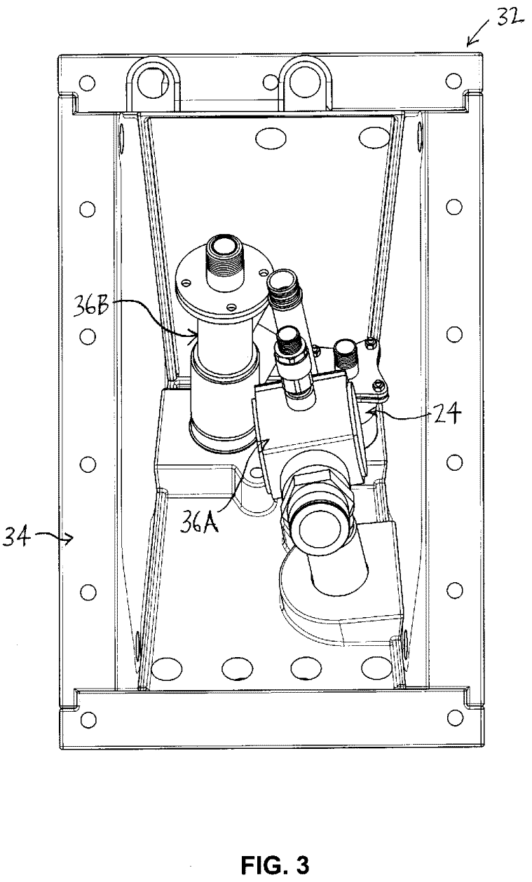

In the panel assembly 32 illustrated in FIG. 3, for example, the panel assembly 32 includes one inspection assembly 24, an injector assembly 36A that is a supersonic carbon injector, and an injector assembly 36B that is a variable oxygen flow burner. It will be understood that the inspection assembly 24 that is included in the panel assembly 32 may include any suitable inspection device 25 (not shown in FIGS. 2-4), e.g., a camera, or a microwave unit.

In some embodiments, the panel assembly 32 may include only the inspection assembly 24.

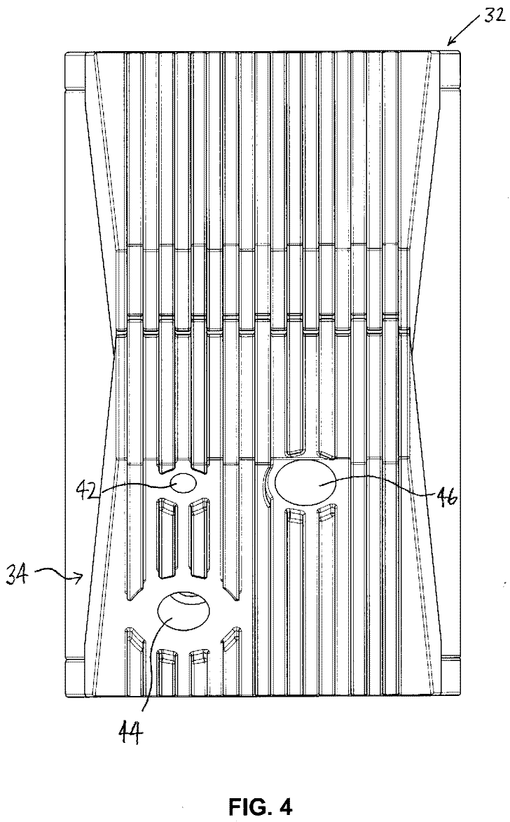

In one embodiment, the panel body 34 may be water-cooled. As can be seen in FIG. 4, the panel body 34 includes openings 42, 44 and 46 in a front side 48 of the panel body 34. In the panel assembly 32 illustrated in FIGS. 2-4, the inspection assembly 24 is mounted for alignment with the opening 42, and the injector assemblies 36A, 36B are mounted for alignment with the openings 44, 46 respectively.

Those skilled in the art would appreciate that more than one panel assembly 32 may be mounted in an electric arc furnace or furnace environment. In the example illustrated in FIG. 6A, for instance, a second panel assembly 32A is also mounted to the wall 31, spaced apart from the other panel assembly 32.

As illustrated in FIG. 6A, the panel assemblies 32, 32A are mounted in the wall 31 to locate the inspection assemblies 24 positioned therein so that preselected information may be obtained about the lower material “L”, exposed portions of the lower material or other characteristics of the furnace environment at respective locations via those inspection assemblies 24. The panel assemblies are located in the wall for positioning the inspection assemblies therein to obtain the preselected information.

In the example of the method of the disclosure illustrated in FIGS. 5A-5C, the inspection assembly 24 first directs the second gas jet “G₂” onto or towards the upper material “W” at the preselected location 26 on the top surface 27 of the upper material “W” (FIG. 5A). The first gas jet “G₁” is also directed from the inspection assembly 24, for protecting and cooling the inspection device 25. In FIGS. 5A and 5B, an arrow “X” indicates the directions of the gas jets “G₁”, “G₂”, which are coaxial in the example illustrated. As can be seen in FIGS. 5A to 5C, the second gas jet “G₂” removes the part 28 of the upper material “W” that is at the preselected location 26, to expose at least the portion 29 of the lower material “L”.

It will be understood that, ideally, the part 28 of the upper material that is displaced by the second gas jet “G₂” is urged thereby in the directions indicated by arrows “A” and “B” in FIG. 5B. Those skilled in the art would appreciate that the part 28 that is so displaced is generally blown onto adjacent parts of the surface 27 of the upper material “W”.

The second gas jet “G₂” is first directed at the predetermined or preselected location 26 on the top surface 27 (FIG. 5A), to displace the part 28 of the upper material “W”. Once the part 28 is displaced, the second gas jet “G₂” may be required to be continuously directed at the exposed portion 29 for a limited or predetermined time period, to keep the portion 29 of the lower material “L” exposed, as illustrated in FIG. 5C. As noted above, it is preferred that the time during which the second gas jet “G₂” is directed into the furnace environment 22 is kept to a minimum or low time period.

While the second gas jet “G₂” is directed onto the process materials “M”, the first gas jet “G₁” is also directed into the furnace environment 22, to protect and to cool the inspection device 25.

As described above, the preselected information is obtained by the inspection device 25 from the exposed portion 29. If the inspection device 25 is a camera, then the preselected information is an image, and if the inspection device 25 is a microwave unit, then the preselected information is the position of the exposed portion. The transmission of the preselected information to the inspection device 25 is schematically represented by arrow “Y” in FIG. 5C.

As noted above, the part 28 of the upper material “W” that is displaced, in order to expose the exposed portion 29 of the lower material “L”, may be blown onto the top surface 27 of the upper material “W” in the immediate vicinity of the exposed portion 29. Those skilled in the art would appreciate that the part 28, once it is blown onto the top surface 27 in the vicinity of the exposed portion 29, will tend to slump over the exposed portion 29 and cover it unless the second gas jet “G₂” is continuously directed at the exposed portion 29, as illustrated in FIG. 5C.

As illustrated in FIG. 5B, in practice, a small part of the lower material “L” may be displaced when the part 28 of the upper material “W” is displaced or blown off the lower material “L” by the second gas jet “G₂”, to expose the exposed portion 29 of the lower material “L”. However, it will be understood that the amounts of the lower material “L” that are inadvertently displaced by the second gas jet “G₂” are not significant.

Once the exposed portion 29 is exposed as described above, the inspection device 25 is utilized, to obtain the preselected information from the exposed portion 29 (FIG. 5C). As an example, if the inspection device 25 is a suitable camera, then the temperature of the lower material “L” may be determined, based on the data from the exposed portion 29. If the inspection device 25 is a microwave unit, then (using signals therefrom reflected off the exposed portion 29 of the lower material “L”), the position of the exposed portion 29 may be determined in relation to the floor “F”.

The advantage provided by the method of the disclosure is that the method enables the operator to obtain the data providing the preselected information (i.e., whether for temperature or for location, or for another parameter) directly from the lower material “L”. More specifically, in some embodiments, the preselected information is obtained from a top surface of the lower material where the top surface of the lower material has been exposed (i.e. the exposed portion 29) by the second or information gathering gas jet.

From the foregoing, it can be seen that, in practice, the second gas jet “G₂” is maintained for a limited time period, as shown in FIG. 5C, in order to keep the exposed portion 29 exposed, and observable. It is understood that exposing the lower material, such as steel, to the elements is not desirable as the lower material may absorb unwanted gases or experience energy loss.

In FIG. 5C, the arrow “Y” schematically represents the transmission of data from the exposed portion 29 to the inspection device 25. For instance, where the inspection device 25 is a microwave unit, the position of the exposed portion relative to the floor “F” may be determined by microwaves transmitted from the microwave unit that are reflected from the exposed portion 29 back to the inspection device 25. Alternatively, where the inspection device 25 is a camera, the arrow “Y” schematically represents the image transmitted to the camera from the exposed portion 29.

As schematically illustrated in FIG. 5C, the data obtained by the inspection device 25 may be transmitted to a remote central processor 50, at which the preselected information is analyzed or processed. Communication between the inspection device 25 and the remote central processor 50 will be understood by one skilled in the art. For instance, if the preselected information is obtained by a camera, then the preselected information may be analyzed by the processor 50 to determine a temperature of the lower material “L”.

Alternatively, a suitable processor (not shown) may be included in the inspection device 25. In one embodiment, the temperature information or other information derived from the camera's data may be utilized in or by the processor 50 to implement changes in process parameters consistent with the preselected information. In other words, if the temperature of the exposed portion 29 of the lower material “L” is determined to be too high with respect to an expected temperature, the processor 50 may transmit a signal to lower a temperature of the furnace environment in order to address the undesirable high temperature of the exposed portion.

Alternatively, if the data is gathered by a microwave unit, then the preselected information may be analyzed by the processor 50 (whether remote or part of the inspection device 25) to determine a position of the exposed portion 29 relative to the floor “F”. In one embodiment, the information regarding the exposed portion's position derived from the microwave unit's data may be utilized in or by the processor to implement changes in process parameters consistent with the preselected information.

It will be understood that the information may be transmitted from the processor to one or more controllers (not shown) that may effect changes in the furnace environment 22 intended to optimize or improve the processes to which the process materials “M” are subjected. For example, if the temperature of the lower material is not optimal or does not fall within a desired temperature range, then steps may be taken to cause the temperature of the furnace environment to stay in desired range. The changes may be automatic (i.e., the changes may be effected by a program) if the temperature is above or below specified limits, or alternatively, the changes may be effected manually by an operator who has been alerted by the system.

In some embodiments, based on the current conditions within the furnace environment, the system may include a controller (such as processor 50) for adjusting the characteristics (i.e. density, volume and/or velocity) of the information gathering jet.

It will be appreciated by those skilled in the art that the disclosure can take many forms, and that such forms are within the scope of the disclosure as claimed. The scope of the claims should not be limited by the preferred embodiments set forth in the examples, but should be given the broadest interpretation consistent with the description as a whole.

We claim:

1. A method of obtaining preselected information in an environment in which process materials are subjected to a process, the process materials including a lower material and an upper material, the upper material positioned at least partially on the lower material, the method comprising:
(a) positioning an inspection assembly for aiming an information gathering gas jet from the inspection assembly into the environment;
(b) directing the information gathering gas jet onto the upper material at a preselected location thereon, wherein the information gathering gas jet displaces a part of the upper material to expose an exposed portion of the lower material or to upwardly propel the lower material; and
(c) with an inspection device, obtaining the preselected information from the lower material.

2. The method of claim 1 wherein the preselected information from the lower material is obtained from a top surface of the lower material.

3. The method of claim 2 wherein the preselected information is an image of the top surface of the lower material.

4. The method of claim 3 wherein the preselected information is microwaves reflected off the top surface of the lower material.

5. The method of claim 1 further comprising:
directing a cooling and protective gas jet from the inspection assembly into the environment.

6. The method of claim 5 wherein a density, volume or velocity of the information gathering jet is different from the cooling and protective gas jet.

7. The method of claim 1 further comprising:
processing the preselected information.

8. The method of claim 7 further comprising:
controlling characteristics of the environment based on the processed preselected information.
